(19) United States
(12) Patent Application Publication
(10) Pub. No.: US 2006/0167799 A1
(43) Pub. Date: Jul. 27, 2006

(54) Client-server-type security system, such as a security system for use with computer network consumer transactions

(76) Inventors: Nathan P. Wehunt, Everett, WA (US); Wen Tseng, Redmond, WA (US); Jeanne Blair, Edmonds, WA (US)

Correspondence Address: PERKINS COIE LLP;PATENT-SEA, P.O. BOX 1247, SEATTLE, WA, 98111-1247, US

(21) Appl. No.: 10/546,225

(22) PCT Filed: Dec. 9, 2004
(86) PCT No.: PCT/US04/41520

§ 371 Date: Aug. 17, 2005

Related U.S. Application Data
(60) Provisional application No. 60/528,925, filed on Dec. 11, 2003.

(51) Int. Cl. G06Q 99/00

(52) U.S. Cl. 705/50

(57) ABSTRACT

A system to provide secure information to a customer or user begins by storing user-defined data associated with a particular user (such as a confidential text string, or image/audio file). The system may then create and provide to the user a communication for the particular user that includes retrieving the user-defined data, and wherein the communication includes the user-defined data in a human perceptible manner and in an unencrypted or unscrambled manner.

### CROSS-REFERENCE TO RELATED APPLICATION(S)

This application claims the benefit of U.S. Provisional Patent Application No. 60/528,925, filed Dec. 11, 2003 (attorney docket number 53005.8013US).

### BACKGROUND

Commerce is increasingly being conducted over large computer networks, such as the Internet. A problem with such electronic commerce is that important, confidential information is sometimes transmitted over insecure channels or using insecure means. Recently, criminals have taken to sending emails to victims, where the emails look as though they came from a legitimate company, such as the victim's bank, with the hopes of tricking the recipient to divulge confidential information (i.e., user id, password, account information, social security number, etc.) such a technique has been referred to as “phishing” or “spoofing.” At times, the emails from such criminals will link the recipient to a web site that looks similar to the true company's web site, but instead be a forgery, or will direct the recipient to the actual company web site, but intercept recipient input information, such as via a pop-up-screen or other means.

### BRIEF DESCRIPTION OF THE DRAWINGS

FIG. 1 is a block diagram of a suitable computer for employing aspects of the invention.

FIG. 2A is a block diagram illustrating a suitable system in which aspects of the invention may operate in a networked computer environment.

FIG. 2B is a block diagram illustrating an alternative system to that of FIG. 2A.

FIG. 3 is a diagram illustrating a suitable environment in which aspects of the invention may be employed, and which shows data flows in that system.

FIG. 4 is a flow diagram illustrating a suitable method performed under this system of FIG. 3.

FIG. 5 is an example of a customer record having a custom identifier associated with the customer.

FIG. 6 is a suitable computer display or web page for providing security information under the system of FIG. 3.

FIG. 7A is a computer screen shot of an example of a bogus phish email.

FIG. 7B is a computer screen shot of an example of a legitimate email.

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

Under one embodiment of the invention, customers or consumers may enter or select a customized phrase, image or other information that a merchant or business includes with every communication to that customer, such as in an email, over the telephone, etc. The message, image, etc. could be changed at any time by the customer, and provides the customer with a level of comfort that communications he or she receives from the business are legitimate, rather than from a criminal fraudulently attempting to obtain information from that customer.

In a broad sense, an aspect of the invention includes a system to provide secure communications to a customer or user, which begins by storing user-defined data associated with a particular user (such as a confidential text string, or image/audio file). The system may then create and provide to the user a communication for the particular user, in a variety of different media, that includes retrieving the user-defined data, and wherein the communication includes the user-defined data in a human perceptible manner and in an unencrypted or unscrambled manner.

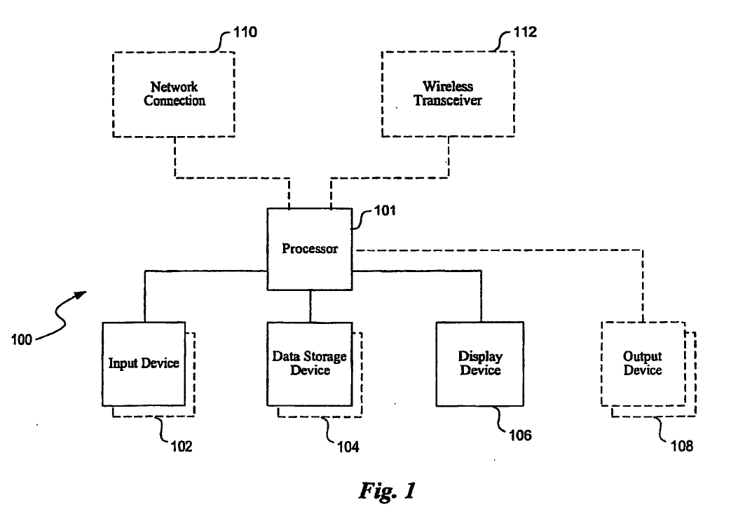

FIG. 1 and the following discussion provide a brief, general description of a suitable computing environment in which aspects of the invention can be implemented. Thereafter, details on embodiments of the invention are provided. Although not required, aspects and embodiments of the invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 1, one embodiment of the invention employs a computer 100, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to a network such as a local area network (LAN), wide area network (WAN) or the Internet (not shown in FIG. 1).

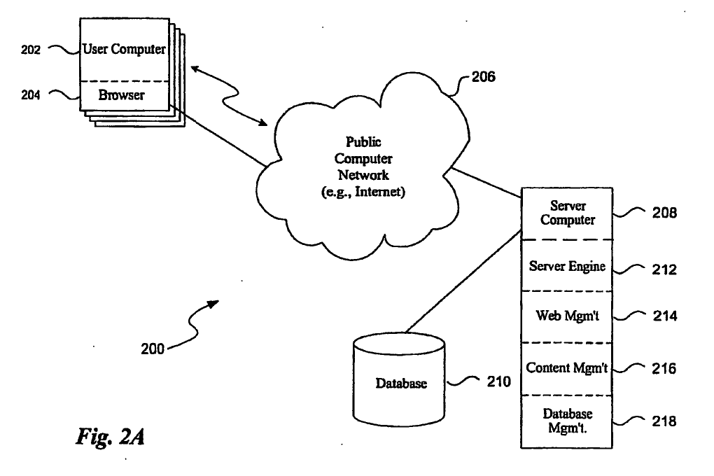

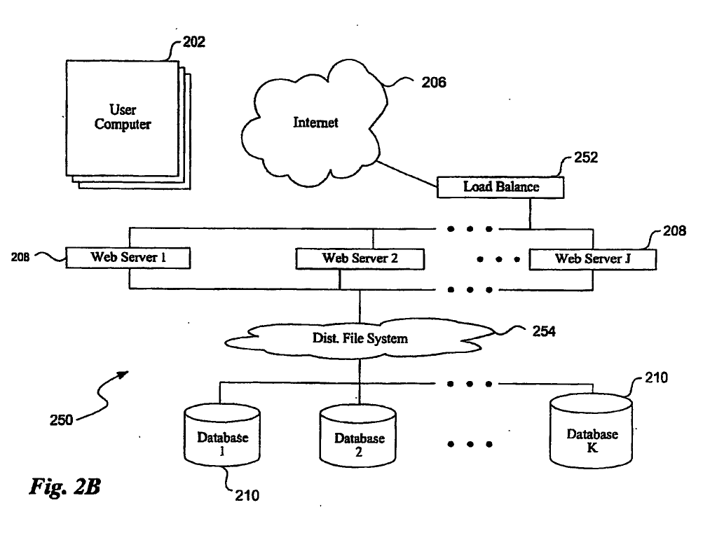

Aspects of the invention may be practiced in a variety of other computing environments. For example, referring to FIG. 2A, a distributed computing environment with a web interface includes one or more user computers 202 in a system 200 are shown, each of which includes a browser program module 204 that permits the computer to access and exchange data with the Internet 206, including web sites within the World Wide Web portion of the Internet. The user computers may include one or more central processing units or other logic-processing circuitry, memory, input devices (e.g., keyboards and pointing devices), output devices (e.g., display devices and printers), and storage devices (e.g., magnetic, fixed and floppy disk drives, and optical disk drives), such as described above with respect to FIG. 1. User computers may include other program modules such as an operating system, one or more application programs (e.g., word processing or spread sheet applications), and the like. The user computers 102 include wireless computers, such as mobile phones, personal digital assistants (PDA's), palm-top computers, etc., which communicate with the Internet via a wireless link. The computers may be general-purpose devices that can be programmed to run various types of applications, or they may be single-purpose devices optimized or limited to a particular function or class of functions.

At least one server computer 208, coupled to the Internet or World Wide Web (“Web”) 206, performs much or all of the functions for receiving, routing and storing of electronic messages, such as web pages, audio signals and electronic images. While the Internet is shown, a private network, such as an Intranet may likewise be used herein. The network may have a client-server architecture, in which a computer is dedicated to serving other client computers, or it may have other architectures such as a peer-to-peer, in which one or more computers serve simultaneously as servers and clients. A database 210 or databases coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216 and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data such as financial information.

Referring to FIG. 2B, an alternative embodiment to the system 200 is shown as a system 250. The system 250 is substantially similar to the system 200, but includes more than one web server computer (shown as server computers 1, 2, . . . J). A web load balancing system 252 balances load on the several web server computers. Load balancing is a technique well-known in the art for distributing the processing load between two or more computers, to thereby more efficiently process instructions and route data. Such a load balancer can distribute message traffic, particularly during peak traffic times.

A distributed file system 254 couples the web servers to several databases (shown as databases 1, 2 . . . K). A distributed file system is a type of file system in which the file system itself manages and transparently locates pieces of information (e.g., content pages) from remote files or databases and distributed files across the network, such as a LAN. The distributed file system also manages read and write functions to the databases.

One skilled in the relevant art will appreciate that the concepts of the invention can be used in various environments other than location based or the Internet. In general, a display description may be in HTML, XML or WAP format, email format or any other format suitable for displaying information (including character/code-based formats, algorithm-based formats (e.g., vector generated), and bitmapped formats). Also, various communication channels, such as local area networks, wide area networks, or point-to-point dial-up connections, may be used instead of the Internet. The system may be conducted within a single computer environment, rather than a client/server environment. Also, the user computers may comprise any combination of hardware or software that interacts with the server computer, such as television-based systems and various other consumer products through which commercial or noncommercial transactions can be conducted. The various aspects of the invention described herein can be implemented in or for any e-mail environment.

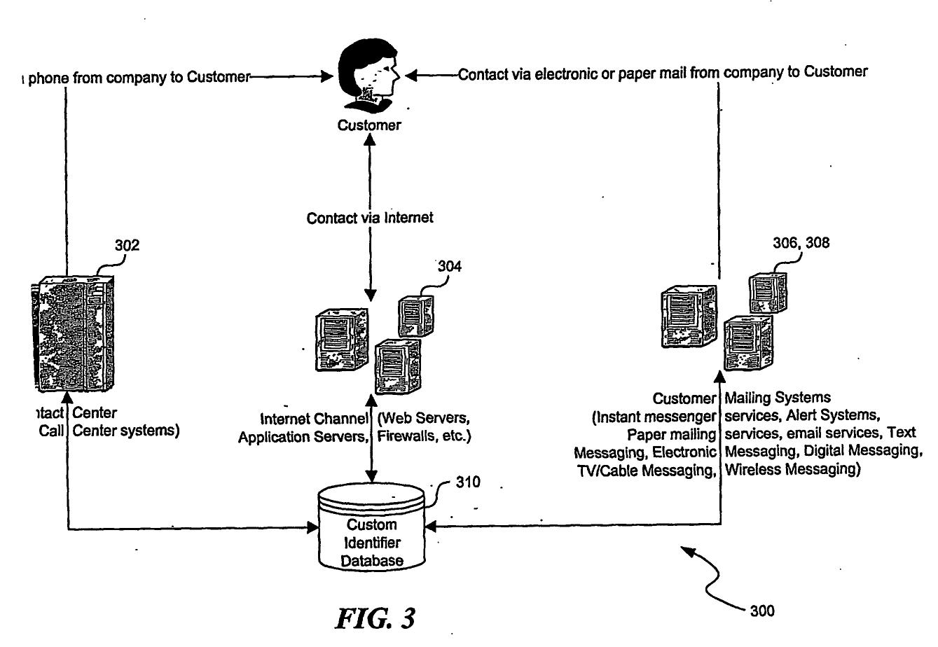

Referring to FIG. 3, a suitable system 300 is shown where a customer or user provides certain custom identifiers, which may be one or more phrases, text strings, images, files (including video/audio/animation files), code or other configurable information (“custom identifier”), which may be included in communications from a given company. Communications from the company may come via multiple delivery channels, such as a telecommunications call center 302, an Internet channel 304, paper mail 306, or electronic mail 308 (all of which computers or computing platforms can employ systems as described above). The customer identifiers are stored in a custom identifier database 310, typically associated with a record associated with each customer (described below). The customer may identify a single custom identifier to be included with each communication, or separate custom identifiers to be associated with different channels (e.g., an image associated with the Internet channel, an audio clip associated with the call center, and a phrase associated with customer mailing systems, SMS (or other text-based services), etc.). The call center 302 may include interactive voice response (IVR) or other computer/telephony equipment that may be automated to provide the customer's custom identifier by phone after navigating touchtone menus (e.g., with the help of text-to-speech functions).

The customer can update the customer identifier via normal customer service interaction, such as visiting a branch or store, interacting with customer service representatives via known means (telephone or Internet), or other back office or contact center methods. The custom identifier would be accessible to anyone in the company that would need to update information or otherwise provide or create outbound communications to the customer. Likewise, the custom identifier is available to any automated system within the company that automatically or semi-automatically generates outbound communications to the customer.

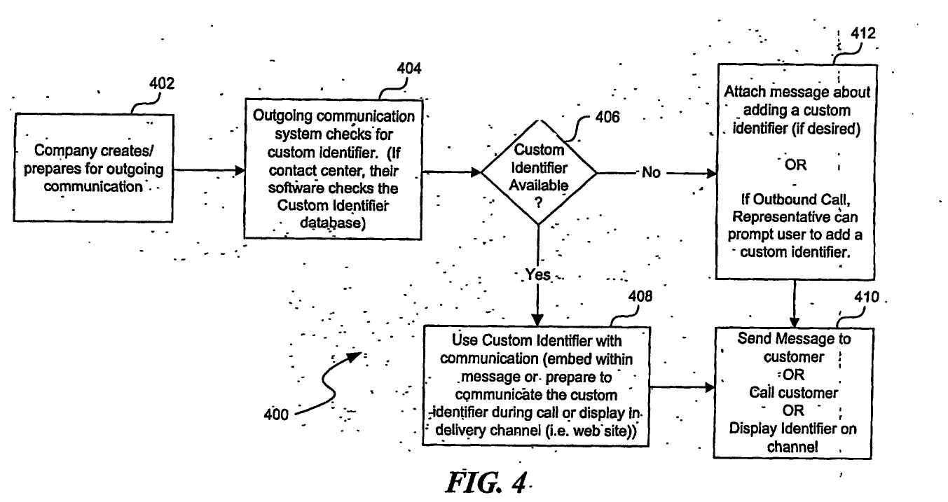

Referring to FIG. 4, a suitable process 400 performed by the company for providing a communication to the customer begins when the company creates and prepares an outgoing communication, such as an email message (block 402). The company's system then checks for a custom identifier associated with a given customer, such as querying the custom identifier database 310 (block 404). If a custom identifier is available (block 406), then it is included within the message, such as embedded within the email message (block 408). The email message is then sent out to the customer (block 410). If, for example, the communication is via a call center, then a pop-up screen may be provided to the call center agent, who can then orally provide the customer identifier information to the customer over the phone. (If the custom identifier is an image, then the call center agent may simply describe what the image shows to the customer over the phone.) Alternatively, the system could replay a stored audio file, associated with the customer, to the customer over the phone link.

If a custom identifier is not available (block 406), then the system may attach or include a message about adding a custom identifier to the customer to prompt the customer to provide such information for future communications. Such a message can be by email, or simply be a call center script to be provided by a call center agent.

Note that the custom identifier does not provide access to information, but instead provides a customer with a reasonable level of assurance that the communication that he or she receives was originated by the company, and thus is authentic. The customer must know that any communication originated by the company will be able to provide such custom identifier in, on or during the communication. The customer need simply verify that the communication provided to him or her included the appropriate custom identifier, to thereby not fall prey to mass emailing/calling/mailing scams posing as the company, since such bogus communications would lack the custom identifier.

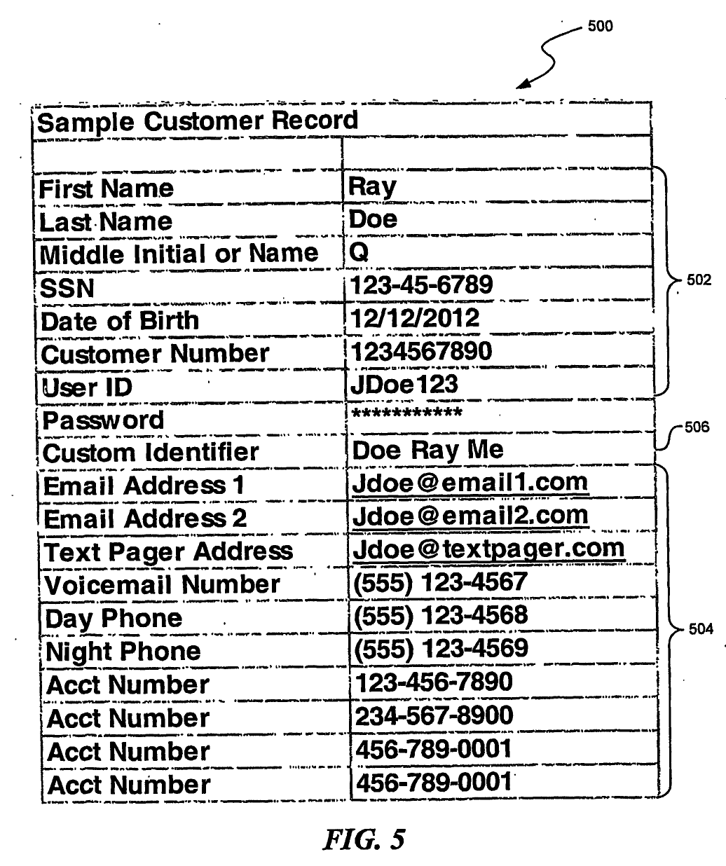

Referring to FIG. 5, an example of a customer record 500 stored in the custom identifier database 310 as shown. As shown in FIG. 5, the customer record includes standard fields 502 for name, social security number, date of birth, customer number, user id and password. It also includes contact information fields 504 such as email addresses, and various phone numbers. Importantly, the customer record also includes at least one custom identifier field 506. While in this example the custom identifier is shown as a text string “Doe Ray Me,” any other information may be stored within the record, as described herein.

While the term “field” and “record” are used herein, any type of data structure can be employed. For example, relevant data can have preceding headers, or other overhead data preceding (or following) the relevant data. Alternatively, relevant data can avoid the use of any overhead data, such as headers, and simply be recognized by a certain byte or series of bytes within a serial data stream. Data structures may conform to conventions of object oriented programming, other types of programming techniques, or both. Any number of data structures and types can be employed herein.

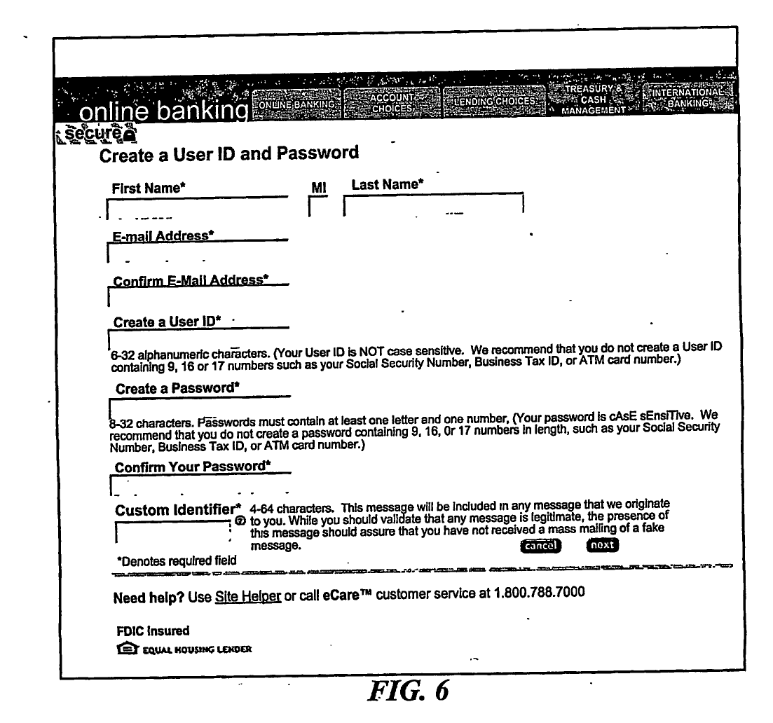

Referring to FIG. 6, an example of a display description, web page, or computer display is shown for allowing the customer to create a user id, password, and custom identifier. The screen may also be used to allow the customer to change any of this information. Of course, any other type of user interface that may be employed to allow the user to enter, update, or edit such information.

In general, a “display description” may be in HTML, XML or, WAP format, email format or any other format suitable for displaying information (including character/code-based formats, algorithm-based formats (e.g., vector generated), and bitmapped or other image formats). Also, various communication channels may be used, such as a local area network, wide area network, or a point-to-point dial-up connection instead of the Internet.

Under alternative embodiments, the custom identifier can expire periodically, which requires the customer to update or change the custom identifier. Of course, standard identification procedures may be provided to the customer to request such a change or update.

The custom identifier can be linked to a time dependent coding system that allows the user to verify when a message was sent, as well as who sent the message. Thus, employing the example of FIG. 5, an email message provided to the customer could include “Doe Ray Me 120103,” where the “Doe Ray Me” corresponds to the user's custom identifier, and the “120103” corresponds to a date of Dec. 1, 2003.

As noted above, the custom identifier can be different depending upon the particular delivery or communication channels. For example, the custom identifier “Doe Ray Me” could be established for text messages, “Doe-A-Deer” could be used for voice mail messages, and a picture of a deer could be used for HTML based email and Internet channel communications.

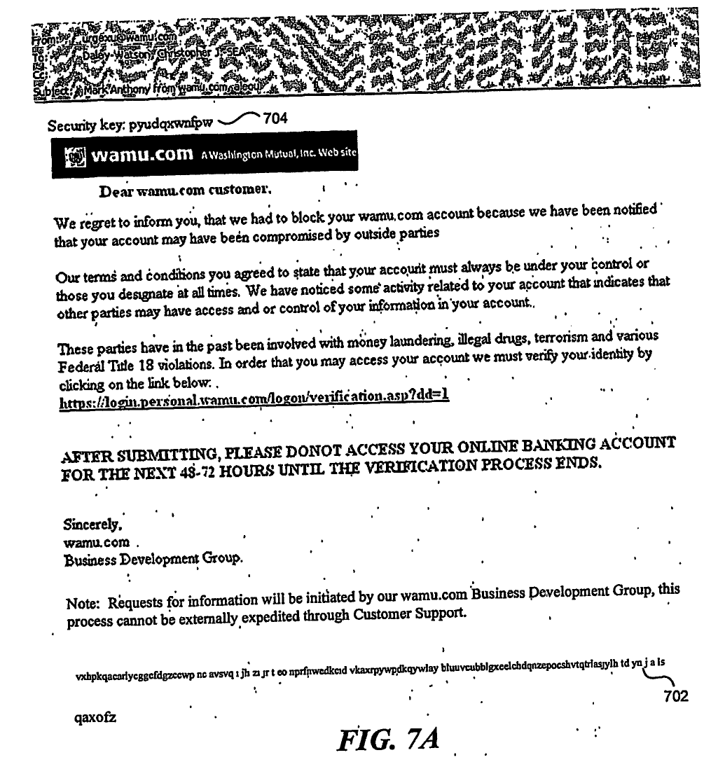

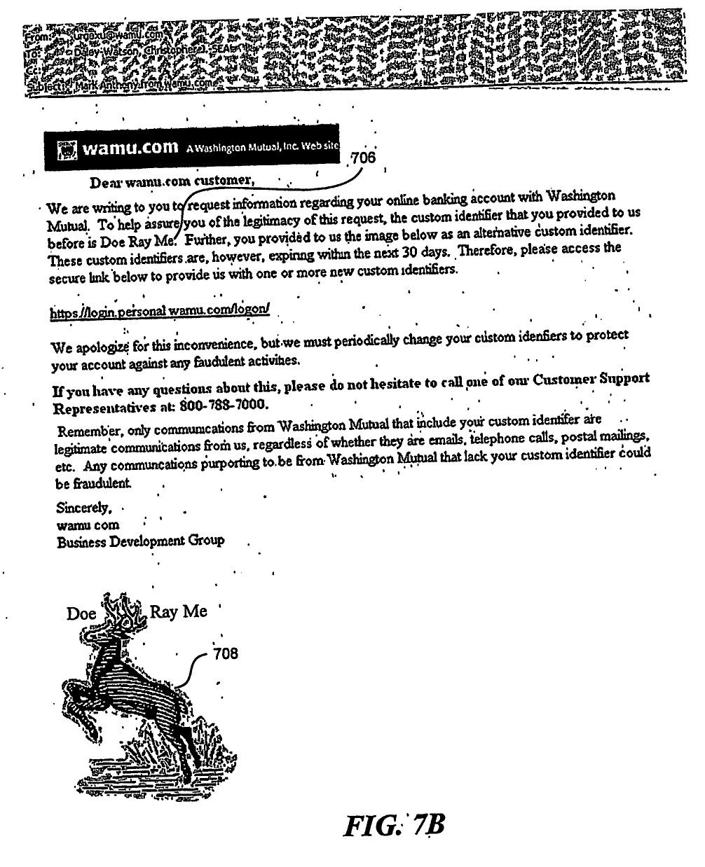

FIG. 7A is an example of a fraudulent phish email. While not visible online (because it is white text on a white background), the email includes some gibberish text 702 that helps this email evade spam filters. Another indication that the email is fraudulent is a bogus security key 704. Further, while not shown, source for this HTML encoded email shows that links or URLs point to websites not affiliated with the purported bank, Washington Mutual.

FIG. 7B shows an example of a legitimate email that correctly includes the customer's custom identifier 706. As shown, the custom identifier is embedded in the text of the email, which thwarts criminals from attempting to access emails and automatically crawl or scan through them to harvest or extract custom identifiers. As an additional safeguard, the image custom identifier may be placed anywhere within the email. In the example of FIG. 7B, an image 708 is shown in the lower left corner. The custom identifier text phrase “Doe Ray Me” are printed over the image 708 so that the image may not be automatically identified in the email, where the text within that image may be the relevant custom identifier. By embedding the text within an image, automated gathering of custom identifiers can be thwarted because many illegitimate programs for gathering such text strings will not be able to readily access a text string embedded within an image.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the security system and method may vary considerably in its implementation details, while still be encompassed by the invention disclosed herein. As noted above, particular terminology used when describing certain features or aspects of the invention should not be taken to imply that the terminology is being re-defined herein to be restricted to any specific characteristics, features or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

1. A client-server security system for use by a financial institution to provide information to multiple client computers associated with customers of the financial institution, the system comprising:
a database storing customer data records, wherein at least some of the customer data records include customer-defined data associated with respective customers, wherein the customer-defined data includes at least one text phrase, one electronic image, or one audio file;
a server computer coupled to the database and configured to provide electronic email messages to customers and to access the customer-defined data in the customer data records;
a telecommunications server computer coupled to the database and configured to access the customer-defined data in the customer data records;
multiple call center computers coupled to the telecommunications server computer and configured to display the customer data records;
wherein the server computer is configured to create email messages initiated by the financial institution and for the client computers, wherein the email messages include information for the customers and include the respective customer-defined data to verify an authenticity of the email message as having been originated by authority of the financial institution;
wherein the telecommunications server computer is configured to provide information and customer records to the call center computers, wherein a call center operator may provide information to a customer, through a telephone call, that includes the customer's respective customer-defined data to verify an authenticity or authority of the call center operator as being affiliated with the financial institution.

2. The system of claim 1 wherein the server computer is also configured to provide the customer-defined data to a printer for printing postal mailings to be provided to the customers, and wherein the customer defined data is embedded within text of the email messages and postal mailings.

3. The system of claim 1 wherein the customer-defined data includes a custom identifier field in each customer record associated with the particular customer, wherein the custom identifier field includes a text string, and either an audio file or and image, and wherein the server computer is further configured to provide information, including the customer-defined data modifications, to customers through a web site provided by the financial institution.

4. In a client-server system, a computer-implemented security method, comprising:
storing user-defined data associated with a particular user at a first time;
at a second time, after the first time, creating a communication for the particular user, including retrieving the user-defined data, and wherein the communication includes the user-defined data in a human perceptible manner and in an unencrypted or unscrambled manner, wherein the communication is not a web page; and
providing the communication with the user-defined data to the particular user.

5. The method of claim 4 wherein storing user-defined data includes storing a custom identifier field in a customer record associated with the particular user, wherein the custom identifier field includes a text string, audio file, or image.

6. The method of claim 4 wherein a first communication is an email message to the user and includes user-defined image data, a second communication is a regular mail message to the user and includes user-defined text data, and a third communication is a telephonic communication to the user and includes user-defined audio data.

7. The method of claim 4 wherein the user-defined data expires after a predetermined time and the user must provide new user-defined data.

8. The method of claim 4 wherein the communication includes a coded time stamp indicating an approximate time the communication was sent.

9. The method of claim 4, further comprising providing an initial communication to the user to prompt the user to provide the user-defined data for storage.

10. The method of claim 4 wherein the user-defined data is a text string embedded in an electronic image file.

11. A computer-readable medium whose contents cause at least one computer to perform a method to provide fraud-reducing communications to customers, the method comprising:
prompting multiple customers for a confidential piece of data;
receiving the confidential data from each of the multiple customers;
storing customer data records having the confidential data from each of the multiple customers and associated with respective customers, wherein the confidential data from each of the multiple customers includes at least one text phrase, one electronic image, or one audio file;
initiating communications to customers by way of at least two different communication channels, wherein at least one of the communication channels is by postal mail or by phone calls;
wherein the communication over the at least one communication channel includes information for the customers and includes the respective confidential data from each of the multiple customers to verify an authenticity of origin for the communication, and wherein communications over the other communication channel likewise includes the confidential data from each of the multiple customers.

12. The computer-readable medium of claim 11 wherein the computer-readable medium is a database associated with a server computer.

13. The computer-readable medium of claim 11 wherein the computer-readable medium is a logical node in a computer network receiving the contents.

14. The computer-readable medium of claim 11 wherein the computer-readable medium is a computer-readable disk.

15. The computer-readable medium of claim 11 wherein the computer-readable medium is a data transmission medium carrying a generated data signal containing the contents.

16. The computer-readable medium of claim 11 wherein the computer-readable medium is a memory of a computer system.

17. An apparatus for providing valid communications to customers of an organization, the apparatus comprising:
means for storing customer-defined data associated with a particular customer at a first time;
means for creating an outbound communication for the particular customer at a second time, after the first time, including retrieving the customer-defined data, and wherein the communication includes the customer-defined data in a human perceptible manner and in an unencrypted or unscrambled manner; and
means for providing the communication with the user-defined data to the particular customer, without a prior request by the particular customer, wherein the communication can be any one of an electronic mail message, a postal mailing, an electronic text message, or a telephone call.

18. The apparatus of claim 17 further comprising means for storing a custom identifier field in a customer record associated with the particular customer, wherein the custom identifier field includes at least two of: a text string, an audio file, and an image.

19. The apparatus of claim 17 further comprising means for providing an initial communication to the customer to prompt the customer to provide the customer-defined data for storage.

20. The apparatus of claim 17 wherein the user-defined data is a text string embedded in an electronic image.

21. A computer-readable medium storing a display description for permitting a computer display device to provide personalized, secure information to a user from a financial institution, comprising:
an electronic communication initiated by the financial institution to the user, and without an initial input or prompting by the user, wherein the communication includes:
a first portion providing the user with information from the financial institution, and requesting information from the user; and
a second portion providing a custom identifier, wherein the custom identifier is a confidential text string, electronic image, or audible file selected by the user and provided to the financial institution at a previous time, and that verifies an authenticity of the communication as having been originated by authority of the financial institution.

22. A computer-readable medium storing a data structure for use by a computer to provide personalized, secure information to a client from an originating institution, the data structure comprising:
a first field of client specific information;
a second field of client specific information, wherein the second field is an electronic address for communicating with the client;
at least a third field of a custom identifier, wherein the custom identifier is a confidential text string, confidential electronic image, or confidential audible file selected by the client for the institution; and
wherein the computer may at least initiate communications with the client by way of the electronic address of the second field, and may provide to the client the custom identifier of the third field to verify an authenticity of the communications as having been originated by authority of the institution.

23. The computer-readable medium of claim 22 wherein the communications are electronic mail communications.

24. The computer-readable medium of claim 22 wherein the communications are telephonic communications.

25. The computer-readable medium of claim 22 wherein the third field includes a client-defined text string, a client-defined audio file, and a client-defined image.

26. A method to provide fraud-reducing communications to users who receive unsolicited communications from an external organization, the method comprising:
receiving a prompt to provide a user-defined piece of data known to or created by the user;
electronically providing to the organization at least an indication of the user-defined data, wherein the user-defined includes at least one text phrase, one electronic image, or one audio file;
receiving a communication from the organization by way of at least two different communication channels, wherein at least one of the communication channels is postal mail or telephone call; and
wherein the communication over the at least one communication channel includes information for the user and includes the user-defined data to verify an authenticity of origin for the communication from the organization, and wherein communications over the other communication channel likewise includes the confidential data from each of the multiple customers.
